(19) United States
(12) Patent Application Publication
(10) Pub. No.: US 2010/0171830 A1
(43) Pub. Date: Jul. 8, 2010

(54) Inside mirror with surveillance camera

(76) Inventor: Chul-hee Lee, Yong-in si (KR)

Correspondence Address: RICHARD F. JAWORSKI;Cooper & Dunham LLP, 30 Rockefeller Plaza, New York, NY, 10112, US

(21) Appl. No.: 12/589,018

(22) Filed: Oct. 16, 2009

(30) Foreign Application Priority Data
Oct. 18, 2008 (KR) 20-2008-0013893

(51) Int. Cl. H04N 7/18

(52) U.S. Cl. 348/148; 348/E07.085

(57) ABSTRACT

A mirror with a frame on the front of the body and which navigation and a circuit and control panel of camera's module can be installed inside, includes an inside camera installed in a jointed structure on an upper part of the body and which can move up and down and side to side, a frontal camera connected to an antenna bracket joined to a back of the body by a ball joining method, a touch screen monitor that can move up and down utilizing a touch sensor button on the front of the body and a removable communication antenna projected from the antenna bracket.

### REFERENCE TO RELATED APPLICATION

The present disclosure is based on and claims the benefit of Korean Patent Application No. 20-2008-0013893 filed on Oct. 18, 2009, the entire contents of which are hereby incorporated by reference.

### BACKGROUND

1. Field of the Disclosure

The present disclosure relates to surveillance cameras and, more particularly, to inside mirrors with surveillance cameras.

2. Description of the Background Art

Generally, a vehicle's inside rearview mirror is fixed along the ceiling of the car's interior to see the back of the car by the light coming through the back window.

However, rearview mirrors have a narrow use and generally have no more abilities than that mentioned above. Although the technology involved with improving inside rearview mirrors has developed as far as improving the mirror itself to, for example, prevent dispersion of light or diffusion of the light at night, generally little or no improvements have been made for adding new abilities or services thereto.

The present disclosure relates to technical improvements to the inside rearview mirror as a safety device and for navigation.

### SUMMARY

A mirror with a frame on the front of the body and which navigation and a circuit and control panel of camera's module can be installed inside, includes an inside camera installed in a jointed structure on an upper part of the body and which can move up and down and side to side, a frontal camera connected to an antenna bracket joined to a back of the body by a ball joining method, a touch screen monitor that can move up and down utilizing a touch sensor button on the front of the body and a removable communication antenna projected from the antenna bracket.

The present disclosure describes an inside (e.g., rearview) mirror with surveillance in the car. Especially the inside mirror with the surveillance films the inside of the car and sends a video clip or photographs randomly to the server, minimizing the damage that a car robbery can produce, provide an exact location by matching the photographed roads and the navigation, and improve the original inside mirror's ability.

### BRIEF DESCRIPTION OF THE DRAWINGS

A more complete appreciation of the present disclosure and many of the attendant advantages thereof will be readily obtained as the same becomes better understood by reference to the following detailed description when considered in connection with the accompanying drawings, wherein:

FIGS. 1a-1c show various views of an inside mirror according to embodiments of the present disclosure;

FIGS. 2a and 2b show side views of an inside mirror according to embodiments of the present disclosure; and

FIGS. 3a and 3B show perspective views of an inside mirror according to embodiments of the present disclosure.

### DETAILED DISCLOSURE

The inside mirror with surveillance inside the car can have navigation and circuit of the camera module and control panel can be installed inside, a mirror (12) with a frame (11) on the front of the rectangular body (10), the inside camera (30) connected to the upper part of the body (10) by joined structure (20) that can make the camera move up and down, the frontal camera (50) connected to the bracket (51) which is connected to the back of the body (10) by the ball joined method (40), a touch screen monitor (60) which can move up an down using the touch sensor button (61) on the side part of the body (10), removable WCDMA antenna (70) projected from the antenna bracket (51) are all contained to improve the expansion of sight of interior and foresight of the car.

Also, the inside mirror with the surveillance in the car has a joined structure (20) that can make the camera inside the car (30) can move up and down forms a scratched handle (31) at the end to assemble, and the side part is connected to the empty semi-circular assembling structural interlocking bracket (32) to control the angle of the camera lens (33) formed at the front.

Also, the inside mirror based on the invention has a microphone (81) set on the upper frame of the frontal mirror (12) of the body (10) so it can record and send the voice.

Also, the inside mirror based on the invention has SD card slot (82) and the member information module slot (83) at the side part of the body (10) so a SD card (84) and the member information module (85) can be inserted.

Also, the ball joining method (40) used on the inside mirror using the invention is composed of an empty interlocking ball (42) fixed on the axis (41) which a line can penetrate and the interlocking tool (43) which has a inside cylindrical surface where interlocking ball (42) can be inserted by force.

The invention is about an inside mirror with surveillance in the car. Especially the inside mirror with the surveillance films the inside of the car and sends a video clip or photographs randomly to the server, minimizing the damage that a car robbery can produce, provide an exact location by matching the photographed roads and the navigation, and improve the original inside mirror's ability.

According to the invention, the inside mirror has a number of abilities such as acting as navigation and safety device, and also has a pro of preventing the crime and driving safely as it also serves its original purpose.

Also, according to the invention, the damage of the car robbery can be minimized and prevented for the camera provides the visual and audio of the crime scene.

Also, because the technology and the member's service program that comes with the invention provide correct evidences at emergency, the police can responds more safely.

Also, by using the customer service program composed with the invention can ease up the necessities needed to save the victim and catch the suspect by marking the robbed car on the navigation and has an effect of preventing the crime when these abilities are well known and installed.

### Specifications

The invention is an altered patent application of Korea patent number 2007-137702 “inside mirror with surveillance”. So the invention is written based on the specification and the diagrams of the patent, especially content on the diagrams are used.

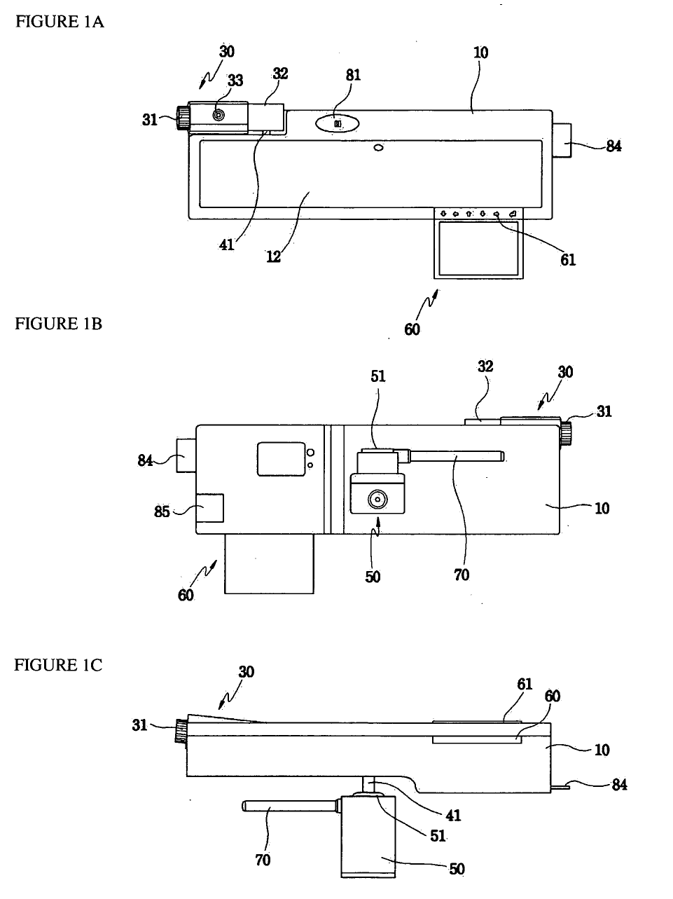

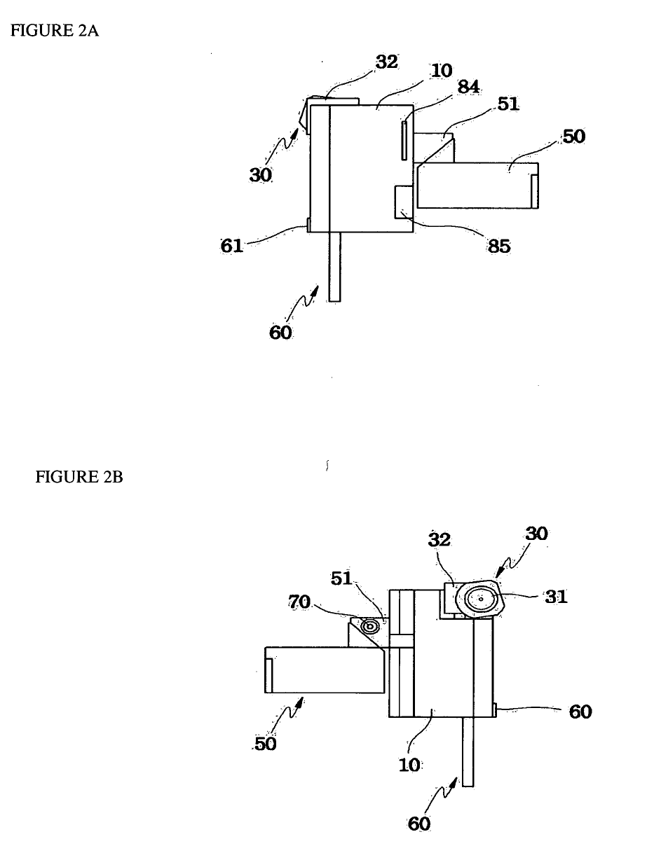

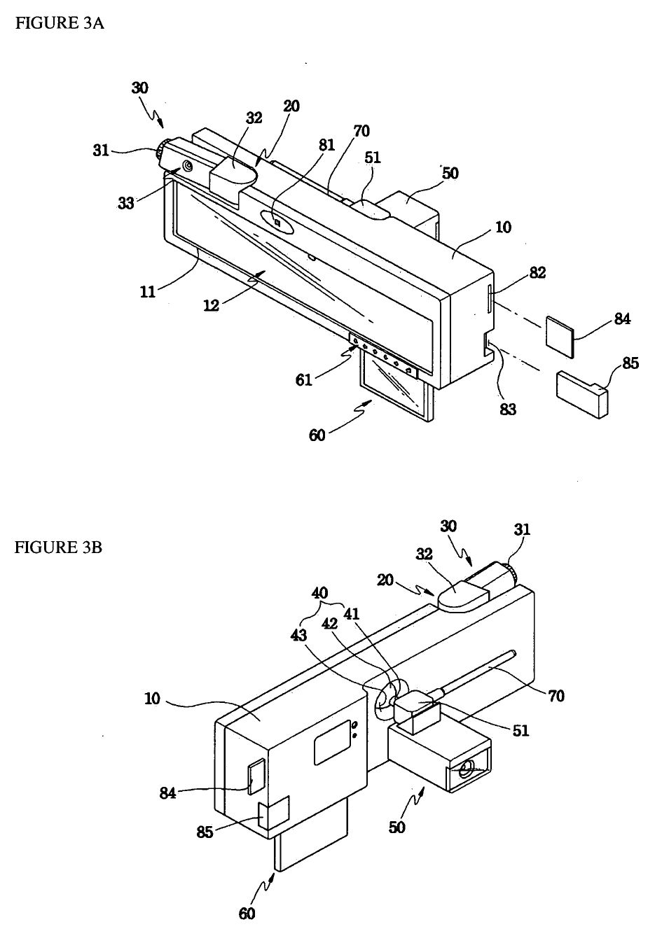

The invention is about the inside mirror with surveillance of the car and the composition and the mechanism are explicitly explained using FIGS. 1-3.

The invention contains a navigation and circuit of the camera module and control panel inside, a mirror (12) with a frame (11) on the front of the rectangular body (10), the inside camera (30) connected to the upper part of the body (10) by joined structure (20) that can make the camera move up and down, and the frontal camera (50) connected to the bracket (51) which is connected to the back of the body (10) by the ball joined method (40).

Also, by using the touch sensor button (61) the touch screen monitor (60) installed on the front part of the body (10) can move up and down, and the WCDMA antenna (70) is projected from the antenna bracket (51). By composing these tools, the sight of interior and foresight of the car and the position of the navigation are improved.

In the invention, the inside mirror has added abilities such as electrical communication besides of having a back-sight. Various circuits are added in the rectangular body (10), including the circuit of camera module for the navigation and the camera.

In the invention, the inside camera (30) makes it possible to film the interior of the car at real time. Through the frontal camera (50), the car can film the foresight. It is to use it at an emergency, and the exact function would be explained later.

The invention has a touch screen monitor (60) that can move up and down installed at the bottom of the body (10) as described. The monitor (60) can follow the method used in here to move up and down. So the photographs and videos taken from the frontal camera (50) and the inside camera (30) can be seen by the driver and also controlled by touching them.

The invention has a special illumination sensor that measures the intensity of illumination so the mirror (12) can have more clear and clean views according to the intensity of light inside the car, and WCDMA antenna is installed so the photographs and the videos the camera took can be sent to the base station.

The invention is similar to the original inside mirror which overall has a rectangular shape but to contain a number of electrical tools to add various functions, it is rather thick. The frontal camera (50) or the inside camera (30) is interlocked to broaden sight.

The invention has a joined structure (20) which makes the inside camera (30) to interlock up and down, forms a scratched handle (31) at the end to assemble and the interlocking bracket (32) of empty semi-circular structure is connected to the frame so the angle of camera lens (33) can be adjusted.

If the handle (31) and the end are turned around, the interlocking bracket (32) adjusts the angle of the camera lens (33) for the bracket (32) connects the frame and the body (10). The interlocking bracket (32) is to make the camera module able to connect with the line and adjust the angle. If the angle can be adjusted, the interior of the car can be filmed without any dead angle.

Next, install a microphone (81) on the upper frame of the frontal mirror (12) on the body (10) so it can record and send the voice. Any noise produced inside the car is recorded and transmitted.

Also, on the side part of the body (10) has SD card slot (82) and the member information module slot (83) at the side part of the body (10) so a SD card (84) and the member information module (85) can be inserted. The SD card slot (82) on the side of the body (10) can be inserted of the SD card (84) and can store photographs and videos in file form and the information module slot (83), if the inside mirrors of the invention are made and distributed through the companies, then the slot would play a role as USIM chip identifying the user and calculate the service provided.

On the other hand, the invention has a special joining relationship between the frontal camera (50) and the body (10). The ball joining method will be explicitly described to accomplish the special relationship.

The ball joining method (40) has an empty interlocking ball (42), which a line can pass through, fixed on the axis and a ball interlocking too (43) which an interlocking ball (42) can be inserted with force. So if the interlocking ball (42) interlocks when connected, then the outside surface of the interlocking ball (42) and the inside surface of the ball interlocking tool (43) produces friction and move the angle as much as wanted.

The interlocking ball (42) in a shape of a ball is formed and the interlocking ball (42) is empty inside. The line passes through the interior of the ball (42) and set up the frontal camera (50). The composition for the interlocking ball (42) is the insider surface of ball interlocking tool (43) against the outside surface of the interlocking ball (42) is a shape of a ball.

According to the invention, the role of the safety device that can protect the driver at an emergency, is played by the inside mirror with the devices installed inside. The frontal camera (50) and the inside camera (30) films and stores the frontal view and the interior of the car at all time in pictures or videos.

If an emergency, such as an accident or a robbery, occurs than by the decision of the driver, the monitoring person, or the specially developed program send the data to the police station. Data such as the frontal photographed views and the GPS signal locating the car transferred to the police station or ca then the police can locate the car with the invention and the views on the inside and outside of the car, making it safer to rescue the driver.

The filmed footage is transmitted to the server al all time and the server transfer the footage to the police station making it possible to achieve inside and outside views are transmitted at real time through videos at real time.

The photographs, pictures and the voice data are saved in the SD card in certain storage unit and can be resaved. The invention uses the HSUPA: High Speed Uplink Packet Access and the HSDPA: High Speed Downlink Packet Access and also the WCDMA: Wideband Code Division Multiple Access.

The present disclosure includes an inside mirror inside the car with the surveillance camera. Especially the inside mirror with the surveillance films the inside of the car and sends a video clip or photographs randomly to the server, minimizing the damage that a car robbery can produce, provide an exact location by matching the photographed roads and the navigation, and improve the original inside mirror's ability.

### EXPLANATIONS OF THE SYMBOLS ON THE DIAGRAMS

10. body
11. frame
12 mirror
20 joining structure
30 inside camera
31 handle
32 interlocking bracket
33 lens
40 ball joining method
41 axis
42 interlocking ball
43 ball interlocking tool
50 frontal cameras
81 microphones
82 SD Card Slot
83 member information module slot
84 SD Card
85. Information Module.

What is claimed is:

1. A mirror with a frame on the front of the body and which navigation and a circuit and control panel of camera's module can be installed inside, comprising:
an inside camera installed in a jointed structure on an upper part of the body and which can move up and down and side to side:
a frontal camera connected to an antenna bracket joined to a back of the body by a ball joining method;
a touch screen monitor that can move up and down utilizing a touch sensor button on the front of the body; and
a removable communication antenna projected from the antenna bracket.

2. The mirror as recited in claim 1, wherein the jointed structure can move the inside camera up and down and comprises a scratched handle at an end of an assembly and a side part that is connected to a semi-circle structure of an interlocking bracket to connect a line and control an angle of sight of the camera lens formed on the front by the handle's interlock.

3. The mirror as recited in claim 1, wherein the ball joining method comprises:
an empty interlocking ball fixed on one axis which a line can penetrate through; and
a ball interlocking tool with an inside cylindrical surface so an interlocking ball can be inserted if forced, wherein the interlocking ball interlocks the ball interlocking tool's inside cylindrical surface and the interlocking ball's outside cylindrical surface creating friction and changing an angle as much as intended.

4. The mirror as recited in claim 1, further comprising a microphone formed at an upper frame of the mirror at a front of the body to record and transmit audio.

5. The mirror as recited in claim 1, further comprising an SD card slot and a member information module slot located at the side part of the body allowing an SD card and a member information module to be inserted.
